(19) United States
(12) Patent Application Publication
(10) Pub. No.: US 2004/0140937 A1
(43) Pub. Date: Jul. 22, 2004

(54) Mobile computer with an integrated directional antenna

(76) Inventor: Yu-Chun Yang, Taipei Shien (TW)

Correspondence Address: RABIN & BERDO, P.C., Suite 500, 1101 14 Street, N.W., Washington, DC, 20005, US

(21) Appl. No.: 10/456,554

(22) Filed: Jun. 9, 2003

(30) Foreign Application Priority Data
Jan. 21, 2003 (TW) 92101283

(51) Int. Cl. H01Q 1/24

(52) U.S. Cl. 343/702

(57) ABSTRACT

A mobile computer with an integrated directional antenna has a mainframe, a display apparatus, a storage structure, a hinge apparatus, and an antenna. The mainframe having a wireless module is connected to the display apparatus. At least an antenna connected to the storage structure via the hinge is electrically connected to the wireless module. The antenna can be stored in the storage structure and can be pulled out to enhance wireless communication quality.

### BACKGROUND OF THE INVENTION

1. Field of Invention

The present invention relates to a mobile/portable computer. More particularly, the present invention relates to a mobile/portable computer with an integrated directional antenna.

2. Description of Related Art

As wireless digital communication advances, wireless communication becomes a basic requirement for mobile computers. For example, a mobile/portable computer has a bluetooth wireless module to communicate with other electronic device. A signal is processed by a wireless communication module, and is transmitted or received by an antenna.

All the antennas of a mobile computer are embedded inside, and the antennas are omnidirectional antennas. However, the omnidirectional antennas are passive to receive signals from any direction. The omnidirectional antenna may receive fading signal, if the antenna receive same signal from two or more directions. In that case, users need to move whole mobile computer for better signal.

For the foregoing reasons, there is a need to solve this problem in a notebook's wireless communication application.

### SUMMARY OF THE INVENTION

It is therefore an objective of the present invention to provide a mobile computer with integrated directional antenna in order to improve signal transfer performance in a wireless network.

In accordance with the foregoing and other objectives of the present invention, a mobile computer with an integrated directional antenna includes a mainframe, a display apparatus, a storage structure, a hinge apparatus, and an antenna. The mainframe having a wireless module is connected with the display apparatus. At least an antenna connected with the storage structure via the hinge is electrically connected to the wireless module. The antenna can be stored in the storage structure and can be pulled out to enhance wireless communication quality.

According to one preferred embodiment of present invention, the antenna can be a microstrip antenna, a panel antenna, a micro-strip array antenna, or a circularized polarized array antenna. The hinge apparatus provide a rotation function with two degrees of freedom. Thus, the directional antenna can be adjusted in any direction because of the hinge apparatus.

In conclusion, present invention provides a mobile computer with an integrated directional antenna to improve signal transfer performance (increasing transmitting and receiving gain) by adjusting the antenna.

It is to be understood that both the foregoing general description and the following detailed description are examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates experimental results of both directional and omni-directional antenna gain modes;

FIG. 2A illustrates perspective view of a mobile computer with a integrated directional antenna according to one preferred embodiment of this invention; and

FIG. 2B illustrates an enlarged view of a directional antenna according to one preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

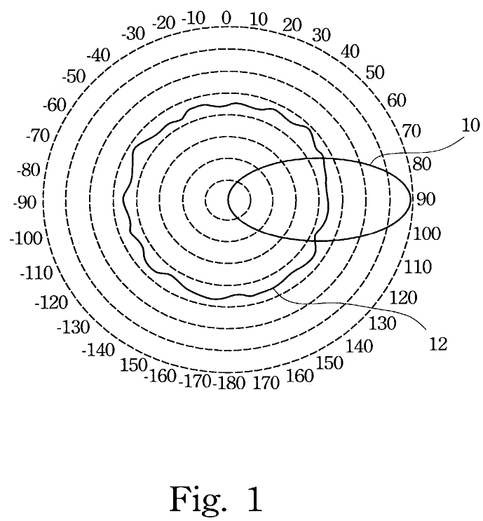

A mobile computer with an embedded directional antenna is described to solve the problem caused by an omnidirectional antenna built inside a mobile computer. FIG. 1 illustrates experimental results of both directional and omnidirectional antenna gain modes. The magnetic field 12 of an omnidirectional antenna forms a sphere around a mobile computer. If the same RF (radio frequency) powers are employed to transmit to both a directional and an omnidirectional antenna, the directional antenna's gain can be increased in specific directions. For example, a magnetic field 10 of a directional antenna can provide long propagation channel in a specific direction. The directional antenna can be achieved by an antenna or a wireless communication module. In one preferred embodiment of the present invention, the directional antenna function is conducted by an antenna.

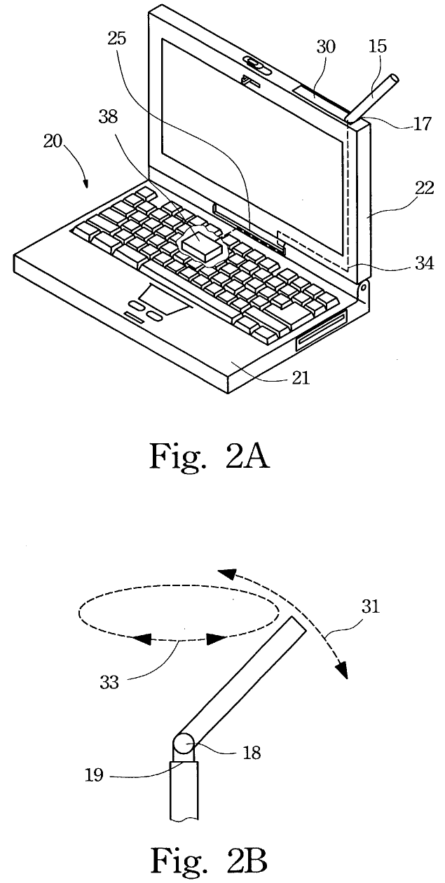

FIG. 2A illustrates perspective view of a mobile computer with an integrated directional antenna according to one preferred embodiment of this invention. The mobile computer 20 includes a mainframe 21, a display means 22, a storage structure 30, an antenna 15, a hinge 17, and a wireless communication module 38. The antenna 15 can be a microstrip antenna, a panel antenna, a micro-strip array antenna, or a circularized polarized array antenna. The antenna 15 is connected to the display means 22 by the hinge 17. The antenna 15 is stored in storage structure 30 when wireless communication is not needed. The antenna 15 is pulled out of the mobile computer 20 (such as the antenna 15 rotate) to improve communication quality during wireless communication. The antenna 15 is electrically connected to the wireless communication module 38 by a signal line 34.

FIG. 2B illustrates an enlarged view of a directional antenna according to one preferred embodiment of this invention. The hinge apparatus 17 provides a rotation function with two degrees of freedom. The hinge 18 provides direction 31, and the hinge 19 provides direction 33. Two degrees of freedom enable an antenna to be guided in any direction in order to increase the antenna gain. In one preferred embodiment of present invention, the antenna 15 is electrically connected to the wireless communication module 38. The wireless communication module 38 includes transmitters, receivers, amplifiers, filters, digital signal processors and other semiconductor components.

In accordance with preferred embodiments described above, the present invention provides a mobile computer with an integrated directional antenna to improve signal transfer performance (increasing transmitting and receiving gain) by adjusting the antenna.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A directional antenna apparatus installed in a mobile computer, said directional antenna apparatus comprising:
a storage structure, installed in an edge of a display apparatus of the mobile computer;
at least one antenna, built inside the storage structure, said antenna electrically connected to a wireless communication module emitting and receiving wireless signals; and
a hinge apparatus, inside said storage structure, employed to link said storage structure and said antenna, said hinge providing a rotation function for said antenna, said antenna rotating out of said mobile computer to obtain a better performance, and said antenna received in said storage structure when not used.

2. The antenna apparatus of claim 1, wherein said antenna includes a microstrip antenna, a panel antenna, a micro-strip array antenna, and a circularized polarized array antenna.

3. The antenna apparatus of claim 2, wherein said hinge apparatus includes a plurality of hinges, each of them providing a degree of freedom.

4. A mobile computer comprising:
a mainframe, having a wireless communication module;
a display means, rotatably connected to said mainframe;
a storage structure, installed in an edge of the display means;
at least one antenna, built inside the storage structure, said antenna electrically connected to a wireless communication module emitting and receiving wireless signals; and
a hinge apparatus, inside said storage structure, employed to link said storage structure and said at least one antenna, said hinge providing a rotation function for said antenna, said antenna rotating out of said mobile computer to obtain a better performance, and said antenna received in said storage structure when not used.

5. The mobile computer of claim 4, wherein said antenna includes a microstrip antenna, a panel antenna, a micro-strip array antenna, and a circularized polarized array antenna.

6. The mobile computer of claim 5, wherein said hinge apparatus includes a plurality of hinges, each of them providing a degree of freedom.
